(19) United States
(12) Patent Application Publication
(10) Pub. No.: US 2009/0016156 A1
(43) Pub. Date: Jan. 15, 2009

(54) Mixer Compound Structure

(76) Inventors: Shinn-Tyan WU, Taoyuan Shieh (TW); Wei-Chuan Chen, Taoyuan Shieh (TW)

Correspondence Address: TROXELL LAW OFFICE PLLC, SUITE 1404, 5205 LEESBURG PIKE, FALLS CHURCH, VA, 22041, US

(21) Appl. No.: 12/172,750

(22) Filed: Jul. 14, 2008

(30) Foreign Application Priority Data
Jul. 13, 2007 (TW) 096211442

(51) Int. Cl. B01F 13/00

(52) U.S. Cl. 366/343

(57) ABSTRACT

A mixer compound structure includes a body and one or a plurality of molded layer; the body contains multiple components; at least one molded layer is given a style or thickness as designed to reduce consumption of the principal material for reducing production cost; the molded mixer is further coated with a surface layer to deliver specific appearance as desired by using surface treatment method to deliver an attractive appearance for the mixer as a whole.

### BACKGROUND OF THE INVENTION

(a) Field of the Invention

The present invention is related to a mixer compound structure, and more particularly, to one that allows style or thickness to be molded as demanded thus to reduce consumption of the principal material for lowering production cost.

(b) Description of the Prior Art

Conventional mixers are usually made using a metal casting method. The body of the conventional mixer though is capable of achieving purposes of regulating water temperature and water amount, and turning on or off the mixer, its body is made by using the casting method, meaning necessary portions including hollow waterway valve chamber are cast by pouring liquid metal before placing core at where a hollow cavity to be formed. In the process, it is very difficult to locate the core and the location of the core will affect production speed and yield. Furthermore, the body cast requires further grinding and polishing processes to consume much manpower, time, and money while dust produced after the grinding and polishing process also presents a very serious environmental problem. If a thicker structure or a structure with a particular appearance is demanded, the metal casting method is less competent to meet the demand of particular style; and full use of metal to make a thicker mixer would incur much more production cost.

To make improvement, a Taiwan utility patent publication No. 284265 titled “Structure of a Molded Plastic Mixer” discloses a mixer entirely made by using an injection molding process. Wherein, hollow plastic components of waterway, water ports, and valve chamber are first made by using the injection molding process before there are combined into a body of the mixer; the mixer is then placed in a mold to be covered up with an external layer by injection molding; multiple ports are respectively formed in symmetrical to where the valve chamber, cold water outlet and hot water outlet to be communicate externally; and the finished product of a plastic mixer is availed. However, in this type of mixer, both of hot water and cold water directly contact the plastic waterway. Serious thermal impact is produced upon the plastic material when directly contacted by hot water; and the capability for the plastic material to take the thermal impact is comparatively weaker. Accordingly, the mixer produced by the injection molding process suffers the problem of durability. Furthermore, as the hot waterway is always at a higher temperature condition due to flow of hot water, after use of longer time chemical substances may get dissolved in the hot water to contaminate water quality. For all these flaws, the mixer produced using the injection molding process is very difficult to get merchandised. Therefore, we could hardly see the similar product available in the market.

### SUMMARY OF THE INVENTION

The primary purpose of the present invention is to provide a compound structure for a mixer that may be produced with the style or thickness as desire thus to reduce consumption of the principal material and to reduce production cost.

To achieve the purpose, a mixer of the present invention includes a body and one or a plurality of molded layer; the body includes multiple components; and the molded layer contains a first molded layer and a second molded layer; the first molded layer is disposed externally to the body and in a style and thickness approximately as that of an molded mixer; and the second molded layer completes a neat and smooth appearance of the mixer as a whole. Using the formation of the first and second molded layers pays to reduce consumption of material for the body thus to further reduce production cost.

Another purpose of the present invention is to provide a surface layer covering up the molded mixer. The surface layer permits surface treatment to deliver different presentation of appearance of the mixer. For example, by commanding electric or chemical plating method, the mixer is given a specific metal gloss as desired for making the mixer more attractive to meet the eye.

### BRIEF DESCRIPTION OF THE DRAWINGS

FIG. 1 is a schematic view showing a construction of a first preferred embodiment of the present invention.

FIG. 2 is a schematic view showing a construction of a second preferred embodiment of the present invention.

FIG. 3 is a schematic view showing a construction of a third preferred embodiment of the present invention.

FIG. 4 is a schematic view showing a construction of a fourth preferred embodiment of the present invention.

### DETAILED DESCRIPTION OF THE PREFERRED EMBODIMENTS

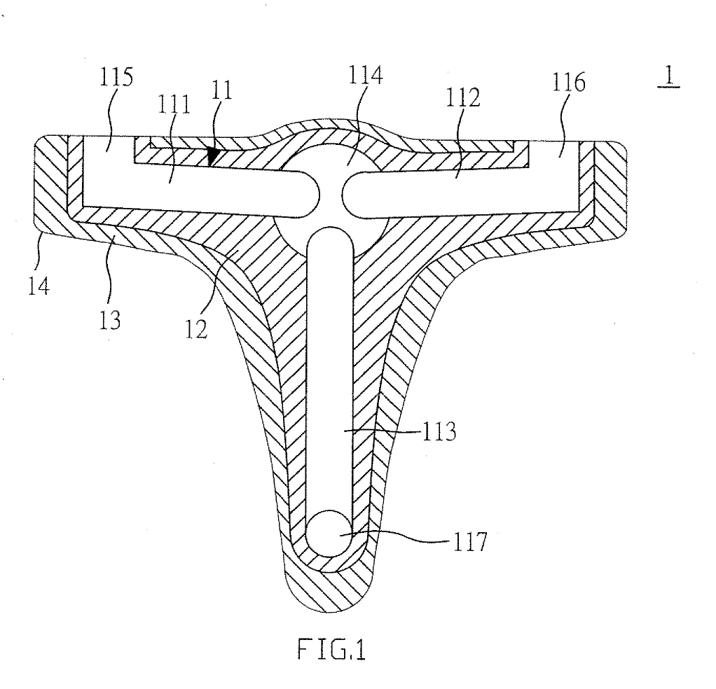

Referring to FIG. 1 for a first preferred embodiment of the present invention, a compound structure of a mixer 1 is comprised of a body 11 a first molded layer 12, a second molded layer 13, and a surface layer 14. The body 11 contains multiple metal components (e.g., made of copper) including a cold waterway 111, a hot waterway 112, a water deliver way 113, and a valve chamber 114 (for placement of a water amount regulation valve) connected to one another one ends respectively of the cold waterway 111, hot waterway 112, and water deliver way 113 are connecting through the valve chamber 114; openings are respectively formed on a cold water inlet 115 of the cold waterway 111, a hot water inlet 116 of the hot waterway 112, and a mixed water deliver 117 outlet of the water deliver way 113 to keep water flowing through them.

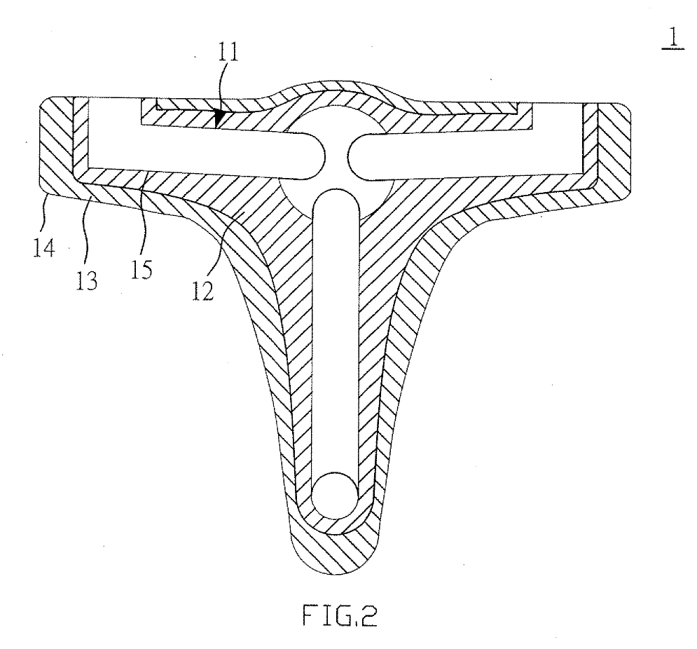

In molding the mixer as a whole, the body 11 is placed in a mold to form the first plastic molded layer externally to the body 11 by injection molding so to give a specific style and thickness as designed for the mixer before proceeding to a second round of injection molding to form the second plastic molded layer 13 externally to the first molded layer 12. The second molded layer 13 constitutes a neat and smooth appearance of the mixer. Finally, the surface layer 14 is provided externally to the second molded layer 13 by surface treatment, e.g., electric or chemical plating, or coating method for the surface layer to resist cleaning by corrosive solution including detergent and to demonstrate specific metal gloss to maintain attractive appearance of the mixer. Wherein, the material coated may be related to a metal powder or ceramic coating. An insulation layer 15 is further provided between the body 11 and the first molded layer 12 in a second preferred embodiment of the present invention as illustrated in FIG. 2 to prevent temperature of hot water flowing in the body from being directly transferred out of the body 11 to cause thermal impacts among the first molded layer 12, the second molded layer 13 and the surface layer 14 while preventing a user to get burned.

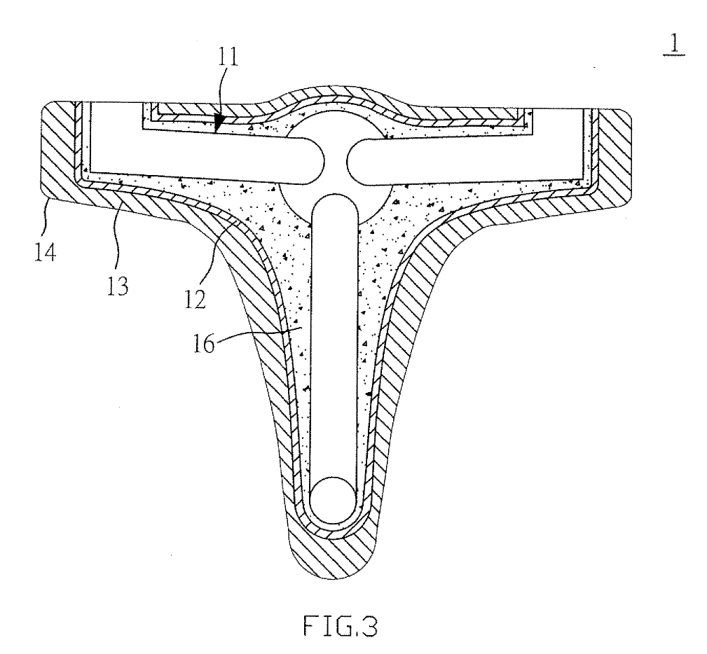

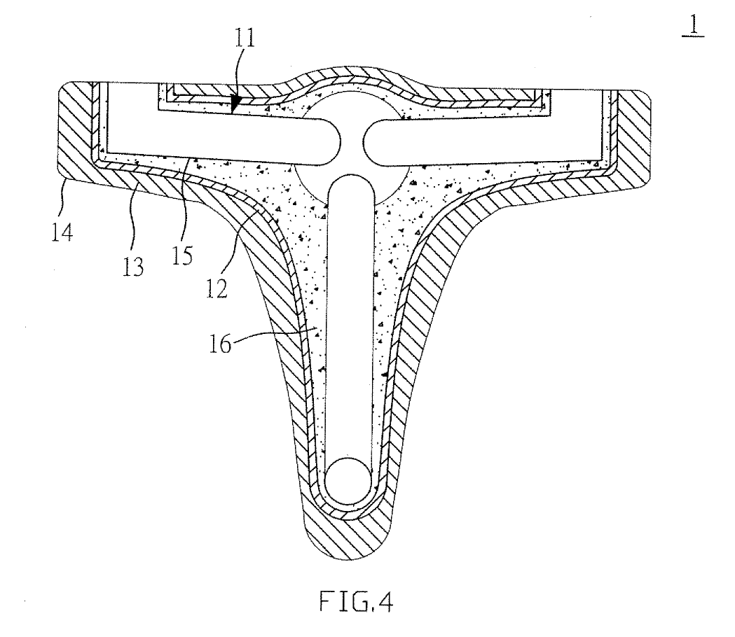

A filling layer 16 is further provided at where between the body and the first molded layer 12 in a third preferred embodiment of the present invention as illustrated in FIG. 3; wherein, the body 11 is first placed in a mold to form by injection molding the plastic filling layer 16 externally to the body 11 in a style of the molded mixer as designed before proceeding a second round of injection molding process to form the first plastic molded layer 12 externally to the filling layer 16 to constitute the thickness of the mixer; then a third round of injection molding process is carried out to form the second plastic molded layer 13 externally to the first molded layer 12 to constitute a neat and smooth appearance of the mixer; and finally, the surface layer 14 is provided externally to the second molded layer 13 by means of surface treatment. Again, the insulation layer 15 is further provided at where between the body 11 and the filling layer 16 in a fourth preferred embodiment of the present invention as illustrated in FIG. 4 to prevent directly transfer of the temperature of hot water flowing in the body 11 to the external of the body 11.

In comparison with the prior art, the present invention delivers the following advantages:

1. All components in the body are combined to one another or are made in an integral part. There is no limit to the material of the body as the mixer may be made of metal material or plastic material with its inner walls processed with metal film, or a blended material as long as the material is provided with water and thermal resisting properties. The body of the mixer of the present invention by delivering excellent thermal resisting property and durability gives longer service life while admitting hot water and cold water to flow through. Contact between hot water and-metal in the present invention is free of developing leaching out chemical substance to contaminate water quality as found in the contact between hot water and plastic material.

2. Whereas the body is wrapped inside the mixer, it requires no surface treatment of grinding and polishing; the external filling layer, the first molded layer, and the second molded layer are made of plastic material to permit fast, and lower cost production; and the elegant and attractive appearance of the finished product of the mixer is achieve without grinding and polishing to invite significant pollution problem as found with the mixer made using metal casting method.

3. The filling layer or the first and the second molded layers may be molded as the structure of the mixer without solely relying upon the body thus to reduce consumption of the material for the body for not only reducing the production cost but also allowing a mixer structure in a style and thickness as designed.

4. The surface layer disposed on the outmost layer of the body is capable of withstanding cleaning by corrosive solutions including detergent while delivering a specific metal gloss as desired to maintain attractive appearance of the mixer.

The prevent invention provides a compound structure for a mixer, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A mixer compound structure comprising:
a body containing multiple components;
a first molded layer disposed externally to the body in a preset style and a given thickness;
a second molded layer provided externally to the first molded layer; and
a surface layer disposed externally to the second molded layer.

2. The mixer compound structure as claimed in claim 1, wherein a filling layer is further disposed at where between the body and the first molded layer.

3. The mixer compound structure as claimed in claim 2, wherein the filling layer is made of plastic material.

4. The mixer compound structure as claimed in claim 1, wherein both of the first and the second molded layers are made of plastic material.

5. The mixer compound structure as claimed in claim 1, wherein the surface layer is provided by using a surface treatment method.

6. The mixer compound structure as claimed in claim 1, wherein the surface layer is formed by using electric or chemical plating method.

7. The mixer compound structure as claimed in claim 1, wherein the surface layer is formed by applying a layer of coating.

8. The mixer compound structure as claimed in claim 7, wherein the coating is related to metal powder or ceramic coating.

9. The mixer compound structure as claimed in claim 1, wherein an insulation layer is further disposed between the body and the first molded layer.

10. The mixer compound structure as claimed in claim 1, wherein the body is comprised of a cold waterway, a hot waterway, a water delivery way, and a valve chamber; one ends respectively of the cold waterway, the hot waterway, and the water delivery way are connected through the valve chamber; and another ends respectively of the cold waterway, the hot waterway, and the water delivery way are each disposed with an opening to maintain water flowing through them.

11. A mixer compound structure comprising:
a body containing multiple components;
a filling layer disposed externally to the body and given in a preset style;
a first molded layer disposed externally to the filling layer and provided with a given thickness; and
a second molded layer provided externally to the first molded layer.

12. A mixer compound structure as claimed in claim 11, wherein the filling layer, and both of the first and the second molded layers are made of plastic material.

13. A mixer compound structure as claimed in claim 11, wherein a surface layer is further disposed externally to the second molded layer.

14. A mixer compound structure as claimed in claim 13, wherein the surface layer is provided by using a surface treatment method.

15. A mixer compound structure as claimed in claim 13, wherein the surface layer is formed by using electric or chemical plating method.

16. A mixer compound structure as claimed in claim 13, wherein the surface layer is formed by applying a layer of coating.

17. A mixer compound structure as claimed in claim 16, wherein the coating is related to metal powder or ceramic coating.

18. A mixer compound structure as claimed in claim 11, wherein an insulation layer is further disposed between the body and the filling layer.

19. A mixer compound structure as claimed in claim 11, wherein the body is comprised of a cold waterway, a hot waterway, a water delivery way, and a valve chamber; one ends respectively of the cold waterway, the hot waterway, and the water delivery way are connected through the valve chamber; and another ends respectively of the cold waterway, the hot waterway, and the water delivery way are each disposed with an opening to maintain water flowing through them.
